(19) United States
(12) Patent Application Publication
(10) Pub. No.: US 2006/0289827 A1
(43) Pub. Date: Dec. 28, 2006

(54) Absorbent with multiple granule sizes

(76) Inventor: Tom Stone, Kannapolis, NC (US)

Correspondence Address: DOUGHERTY CLEMENTS, 1901 ROXBOROUGH ROAD, SUITE 300, CHARLOTTE, NC, 28211, US

(21) Appl. No.: 11/474,703

(22) Filed: Jun. 26, 2006

Related U.S. Application Data
(60) Provisional application No. 60/693,887, filed on Jun. 27, 2005.

(51) Int. Cl. C09K 3/22

(52) U.S. Cl. 252/88.1; 141/114

(57) ABSTRACT

A method of controlling dust formation during the manufacture and handling of metallic oxide absorbents, a method of selectively packaging the same, and a resulting reduced dusting composition. A first metallic oxide having a mean particle density is blended with a second metallic oxide having a mean particle density different from the first metallic oxide. The composition is blended with from about 5 to about 15 wt. % water to achieve a homogeneous mixture. A powdered detergent can optionally be added to facilitate stain removal.

### CROSS-REFERENCE TO RELATED APPLICATION

This application claims the benefit of the Provisional Patent Application Ser. No. 60/693,887 filed on Jun. 24, 2005.

### FIELD OF THE INVENTION

The present invention relates to methods, systems and products for controlling dust formation during the manufacture and usage of metallic oxide absorbents. More specifically, the present invention relates to methods, systems, and products for controlling dust formation during the manufacture and usage of metallic oxide absorbents, wherein a plurality of metallic oxide particle sizes are utilized. Furthermore, the present invention relates to methods, systems, and products for controlling dust formation during the manufacture and usage of metallic oxide absorbents, wherein a plurality of metallic oxide particle sizes are utilized in conjunction with a mixed amount of a dust limiting liquid.

### BACKGROUND OF THE INVENTION

Perlite is a generic term for naturally occurring siliceous volcanic rock having between two to six percent combined water in the crude rock. A typical chemical analysis of perlite is shown in Table 1. When quickly heated to above 1600° F. (870° C.) the siliceous rock pops in a manner similar to popcorn as the water vaporizes and creates countless tiny bubbles in the heat softened glassy particles.

TABLE 1

| Typical Elemental Analysis (wt. %) | |
|---|---|
| Oxygen | 47.5 |
| Silicon | 34.0 |
| Aluminum | 7.0 |
| Potassium | 3.5 |
| Sodium | 3.5 |
| Iron | 0.5 |
| Calcium | 0.5 |
| Magnesium | 0.25 |
| Other Trace Metals | 0.25 |
| Water | 3.0 |
| Total | 100.0 |

*Elements are present in mixed glassy silicates compounds, as well as free silica. Slight variations can be expected from different sources.

Expanded perlite can be manufactured to weigh from 2 lb/ft³ (32 kg/m³) to 15 lb/ft³ (240 kg/m³) making it especially suitable for use in a variety of insulation and absorption applications. Typical physical properties are shown in Table 2.

TABLE 2
Typical Physical Properties

| | |
|---|---|
| Color | White |
| Refractive Index | 1.5 |
| Maximum Free Moisture | 0.5% |
| Specific Gravity | 2.2-2.4 |
| Bulk Density (loose weight) | As desired but usually in the 2-25 lb/ft³ |
| | range (32-400 kg/m³) |
| Softening Point | 1600-2000° F. (871-1093° C.) |
| Fusion Point | 2300-2450° F. (1260-1343° C.) |
| Specific Heat | 0.2 Btu/lb·° F. (387 J/kg·K) |
| Thermal Conductivity at | .27-.41 Btu·in/h·ft²·° F. (.04-.06 W/m·K) |
| 75° F. (24° C.) | |

It is known to utilize the expanded perlite for the cleanup and absorption of petroleum and aqueous based spills. These expanded perlite absorbents have a porous structure that is ideal for retaining absorbed liquids. However, due to the lightweight structure of the expanded perlite, the manufacture and subsequent use of the material results in extreme amounts of dust that can contaminate the manufacturing facility, requiring extensive cleanup and downtime. Additionally, inhalation of the expanded perlite dust is irritating to those who work with it and around it.

U.S. Pat. No. 2,728,733 issued to Hashimoto discloses a light weight aggregate made from expanded perlite fines and clay. Perlite fines are mixed with the clay in a dry powder, while water is slowly added. The powder aggregates into small individual pellets.

U.S. Pat. No. 4,105,576 issued to Seidenberger discloses a granular composition for cleaning up caustic spills. The composition contains citric acid, flour, fumed silica, a pH indicator, and 12.0-21.0 wt. % expanded perlite.

U.S. Pat. No. 4,148,941 issued to Pape et al. discloses a process for dust reduction in the treatment of expanded perlite. Perlite fines are bonded to larger sized perlite particles by spraying the particles with a paraffin mist.

U.S. Pat. No. 5,035,804 issued to Stowe discloses a composition for the removal of oil from the surface of water. The composition is coated with oleophilic/hydrophobic layer comprising sulfur, metallic sulfates, alkali metal nitrates, and burned hydrocarbon oils. The composition can contain expanded perlite or vermiculite.

U.S. Pat. No. 5,632,889 issued to Tharp discloses a filter cartridge for selectively absorbing oils from water. The absorption media is silicone treated expanded perlite.

U.S. Pat. Nos. 6,464,770 and 6,712,889 issued to Palm et al. disclose an expanded perlite with a controlled particle size distribution. Particles are filtered through a mechanical sieve to control size distribution.

Despite the level of knowledge in the art relating to metallic oxide absorbents, there is a need to control the dust formation during the manufacture, packaging, and use of the metallic oxide absorbents. There remains room for improvement in this area of the art.

### SUMMARY OF THE INVENTION

The invention provides methods for producing and compositions of a homogeneous powdered metallic oxide absorbent having decreased dust formation during manufacture and subsequent usage.

The invention relates to the use of at least two different particle metallic oxide particle sizes in order to create a composition that has reduced dust formation.

The invention further relates to methods producing and compositions of at least two different sized metallic oxide particles, wherein a given amount of water is added during processing to aid in the prevention of dust formation.

The invention further relates to methods for producing and compositions of at least two different sized metallic oxide particles wherein the first metallic oxide particles have a mean particle size of from about 2.5 lb/ft³ to about 6.5 lb/ft³ and the second metallic oxide particles have a mean particle size of from about 6.5 lb/ft³ to about 10.5 lb/ft³.

The invention further relates to the use of metallic oxide particles that are hydrophobic and can absorb a substantial amount of petroleum product per gram of particles. Additionally, the metallic oxide containing particles are substantially non-leaching, nonbiodegradable, nontoxic, inert, nonflammable, insoluble in water and have a high melting point. The resulting particle composition is capable of passing the EPA's Toxicity Characteristic Leaching Procedure, ASTM D2974, the Liquid Release Test (method 9096), and the Paint Filter Liquids Test (method 9095A).

### OBJECTS OF THE INVENTION

The principal object of the invention is to provide a metallic oxide absorbent composition and a method for manufacture thereof, wherein the composition exhibits reduced dust formation during the manufacture and subsequent use thereof.

Another object of the invention is to provide a metallic oxide absorbent composition and a method of manufacture thereof, wherein the composition comprises a plurality of particle sizes.

Another object of the invention is to provide a metallic oxide absorbent composition and a method of manufacture thereof, wherein the absorbent composition is capable of passing various environmental tests for liquid retention and land fill use, including the EPA's Toxicity Characteristic Leaching Procedure, ASTM D2974, the Liquid Release Test (method 9096), and the Paint Filter Liquids Test (method 9095A).

### BRIEF DESCRIPTION OF THE DRAWINGS

FIG. 1 is a perspective view of a hopper and screw conveyor as used in the currently described method.

FIG. 2 is a cross-sectional view of a screw conveyor as used in the currently described method.

FIG. 3 is a simplified cross-sectional view of the distribution of expanded perlite after active percolation.

FIG. 4 is a simplified cross-sectional view of the distribution of expanded perlite after elutriation segregation.

### DETAILED DESCRIPTION

An expanded perlite composition is provided. The perlite composition typically will contain from about 71.0 to about 75.0 wt. % silicon dioxide, from about 12.5 to about 18.0 wt. % aluminum oxide, from about 4.0 to about 5.0 wt. % potassium oxide, from about 2.9 to about 4.0 wt. % sodium oxide, and small amounts of other metal oxides and dioxides, including calcium, iron, magnesium, titanium, manganese, and sulfur.

Processing of expanded perlite results in particles having a range of particle densities. Typically expanded perlite has a density from about 2.5 lb/ft³ to about 10.5 lb/ft³ depending on the moisture content of the unexpanded perlite. The expansion process results in a largely homogeneous mixture of particles, with a distribution of densities that largely falls within the stated range of from about 2.5 lb/ft³ to about 10.5 lb/ft³. Various particle densities can be utilized to fill a variety of functions, with certain particle densities being more desirable for certain applications than other particle densities. For example, it has been found that a larger particle density will typically perform better in an outdoor environment, because it is not as easily displaced by adverse environmental conditions. However, where environmental concerns are not as prevalent, such as in the interior of a machine or automotive shop, it has been found that a less dense expanded perlite is preferable. For spill containment purposes, the less dense expanded perlite will have a higher surface to volume ratio, and therefore be able to contain a larger quantity of liquid material.

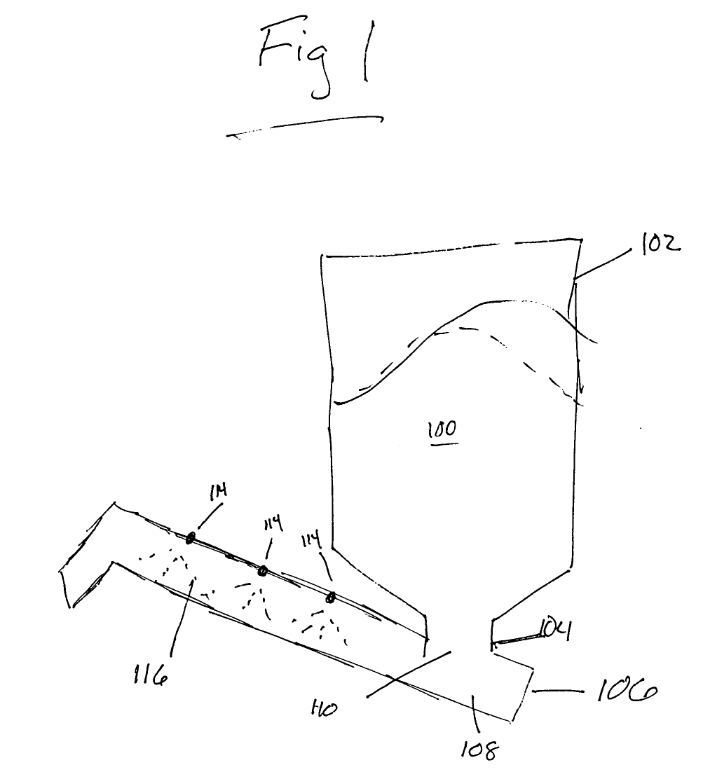

Referring now to FIG. 1, expanded perlite 100 is batched into a hopper 102. As expanded perlite enters the hopper, it is subjected to sequential segregation of the perlite, based on its relative density and particle size. Differences in size, density, shape and resilience can all contribute to particle segregation.

Primarily, segregation of the expanded perlite in the current system is achieved by an active percolation process. When a mass of particles is disturbed (by stirring, shaking, vibrating) such that the individual particles move relative to each other, a rearrangement in the packing of those particles occurs. If a powder has a size distribution, smaller particles move into the void spaces between larger particles during the disturbance at a faster rate than the relative movement of larger particles. This creates a tendency in a disturbed storage hopper for small particles to migrate downward in the direction of gravity, and larger particles to migrate upward. Even small size differences can cause a measurable segregation. This will occur despite the smaller particles having a lesser density than the larger ones.

Elutriation segregation on the other hand has the opposite effect. Often when powder is poured into the top of a hopper, the large volume of air that is displaced can suspend smaller particles. Thus, the fines are suspended, while coarse particles settle to the bottom of the hopper. The fines will eventually settle on top, creating a layer that is more heavily concentrated in the fines.

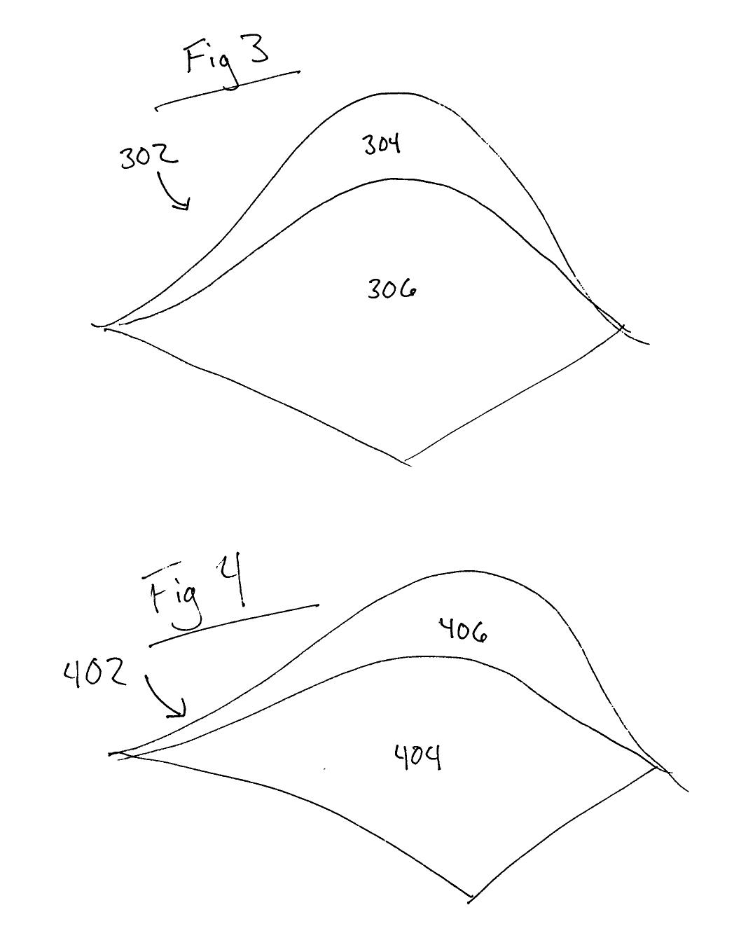

A simplified view of these phenomena is shown in FIG. 3, depicting the percolation effect, and 4, depicting the elutriation segregation. While one can appreciate that the current system will have a continuum of particle sizes, for simplicity, FIG. 3 shows only large particles 304, and small particles 306. Similarly, FIG. 4 shows only large particles 404, and small particles 406. After active percolation has occurred, the large particles 304 have migrated toward the top of the mound 302, and small particles 306 have migrated toward the bottom of the mound 302. As oppositely shown in FIG. 4, after elutriation segregation has occurred, the large particles 404 have migrated toward the bottom of the mound 402, and small particles 406 have migrated toward the top of the mound 402.

The hopper 102 is actively vibrated to induce segregation of the expanded perlite into a. Vibration can be imparted to the hopper 102 by any means known in the art, through a devoted system, or through incidental vibration of attached mechanisms, such as the screw conveyor 106 described infra. Expanded perlite exhibits a general inverse correlation between particle size and particle density. Thus, through active percolation, particles having a smaller density end up closer to the exit port 104 than do the particles having a larger density.

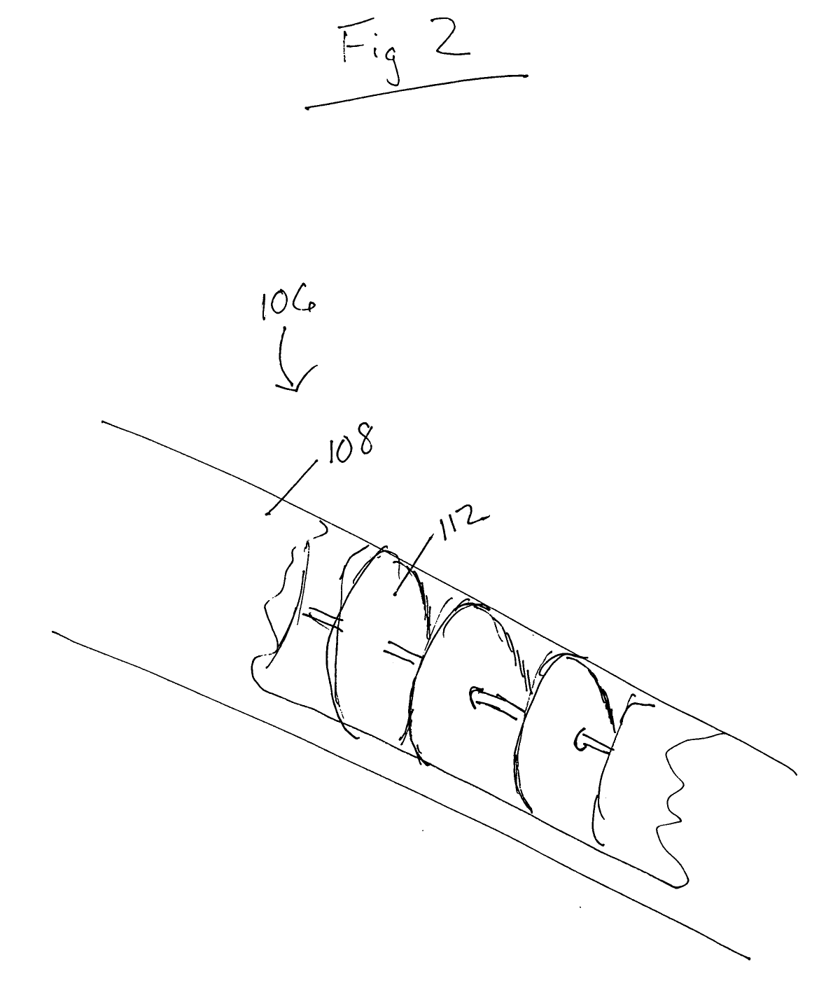

Referring now to FIGS. 1 and 2, Expanded perlite 100 that has been actively segregated is allowed to exit from the hopper at the exit port 104, and to pass into the trough 108 of screw conveyor 106 at its inlet port 110. The conveyor screw 112 rotates within the trough 108, and imparts to the expanded perlite 100 a smooth, positive motion along the trough 108.

Liquid injection ports 114 are located along the trough 108. As the expanded perlite 100 passes in proximity to each liquid injection port 114, a measured amount of fluid 116 is added to the expanded perlite. The fluid can be any fluid known in the art, but is most preferably water. By adding from about 5 to about 15 wt. % water to the expanded perlite, a composition can be achieved that exhibits excellent absorbency, and significantly reduced dusting over a non-moistened expanded perlite composition.

Through the continuous rotation of the conveyor screw 112, fluid 116 is thoroughly mixed into the expanded perlite 100 to form a roughly homogeneous composition. Preferably, fluid 116 is added along the trough 108 at a plurality of liquid injection ports 114, to prevent localized saturation of the expanded perlite. It is believed that such stepwise addition also promotes a more homogeneous composition.

Conveyor screw 112 continues to move the expanded perlite 100 along the trough 108 until the perlite 100 reaches the trough's discharge opening 118. At the discharge opening 118, the expanded perlite 100 exits the screw conveyor 106, and is packaged within a moisture resistant packaging material 120, such as polyester bags, polyethylene bags or other material that is known in the art. The expanded perlite should be packaged into such containers to avoid loss of moisture from the composition.

Because of the distribution of particle densities that occurred due to the active percolation, expanded perlite having a smaller density is removed first from the hopper. Thus, for a given batch, each successive bag of expanded perlite that is packaged will have a density that is progressively higher than the bags preceding it.

Optionally, a detergent can be added to the expanded perlite composition. The detergent can include surfactants, abrasives, pH modifiers, oxidants, enzymes, or other materials that are known in the art. Preferably, the detergent can be borax, or other hydrated or dehydrated mineral oxides. The detergent can be added into the hopper in batch form, or can be added to the perlite material at a later processing stage to prevent undesired segregation of the detergent due to percolation.

Further, the improved composition fully complies with various environmental tests for liquid retention and landfill use, including the EPA's Toxicity Characteristic Leaching Procedure, ASTM D2974, the Liquid Release Test (method 9096), and the Paint Filter Liquids Test (method 9095A).

### SUMMARY OF THE ACHIEVEMENTS OF THE INVENTION

From the foregoing, it is obvious that I have invented a new method and composition for controlling dust formation during the manufacture and handling of metallic oxide and alumina oxide absorbents, wherein a plurality of different sized silicon oxides, and aluminum oxide particles are combined with from about 5 to about 15 wt. % water to achieve an absorbent composition that has excellent dust control and absorbent properties.

Further, the present invention provides a silica/alumina absorbent composition and a method of manufacture thereof, wherein the composition comprises a plurality of particle sizes.

Further, the present invention provides a silica/alumina absorbent composition and a method of manufacture thereof, wherein the absorbent composition is capable of passing various environmental tests for liquid retention and landfill use, including the EPA's Toxicity Characteristic Leaching Procedure, ASTM D2974, the Liquid Release Test (method 9096), and the Paint Filter Liquids Test (method 9095A).

What is claimed is:

1. A method for reducing dust formation and material loss during packaging of expanded perlite, comprising:
a. providing a screw auger having at least one liquid injection port;
b. passing expanded perlite through said screw auger;
c. adding from said liquid injection port from about 5 to about 15 wt. % water to said expanded perlite to achieve a homogeneous absorbent composition;
d. packaging said expanded perlite within at least one moisture resistant bag so as to retain said about 5 to about 15 wt. % water content within said expanded perlite.

2. The method of claim 1, wherein said expanded perlite has a mean particle density of from about 2.5 lb/ft³ to about 10.5 lb/ft³.

3. The method of claim 2, further comprising the steps of
a. prior to passing said expanded perlite through said screw auger, selectively segregating said expanded perlite into a continuum of mean particle densities of from about 2.5 lb/ft³ to about 10.5 lb/ft3; and
b. introducing into said screw auger progressively increasing densities of said segregated expanded perlite.

4. The method of claim 3, wherein expanded perlite is packaged within at least a first bag, and a last bag, said first bag having a lower mean particle density than said last bag.

5. The method of claim 4, wherein said expanded perlite is packaged within at least a first bag, a last bag, and a plurality of intervening bags, wherein the mean particle density of each bag progressively increases from said first bag, through said plurality of intervening bags, to said last bag.

6. A method of selectively packaging an expanded perlite composition, said method comprising: providing a screw auger having at least one liquid injection port;
a. passing expanded perlite through said screw auger;
b. adding from said liquid injection port from about 5 to about 15 wt. % water to said expanded perlite to achieve a homogeneous absorbent composition;
c. packaging said expanded perlite within at least one moisture resistant bag so as to retain said about 5 to about 15 wt. % water content within said expanded perlite.

7. The method of claim 6, wherein said expanded perlite has a mean particle density of from about 2.5 lb/ft³ to about 10.5 lb/ft³.

8. The method of claim 7, further comprising the steps of
a. prior to passing said expanded perlite through said screw auger, selectively filtering said expanded perlite into a continuum of mean particle densities of from about 2.5 lb/ft³ to about 10.5 lb/ft³; and
b. introducing into said screw auger said expanded perlite, of said heavy portion, and a progressively decreasing amount of said light portion.

9. The method of claim 8, wherein expanded perlite is packaged within at least a first bag, and a last bag, said first bag having a lower mean particle density than said last bag.

10. The method of claim 9, wherein said expanded perlite is packaged within at least a first bag, a last bag, and a plurality of intervening bags, wherein the mean particle density of each bag progressively increases from said first bag, through said plurality of intervening bags, to said last bag.

11. The method of claim 8, wherein expanded perlite is packaged within at least a first bag, and a last bag, said last bag having a lower mean particle density than said first bag.

12. The method of claim 9, wherein said expanded perlite is packaged within at least a first bag, a last bag, and a plurality of intervening bags, wherein the mean particle density of each bag progressively decreases from said first bag, through said plurality of intervening bags, to said last bag.
